(19) United States
(12) Patent Application Publication
(10) Pub. No.: US 2013/0343403 A1
(43) Pub. Date: Dec. 26, 2013

(54) Retransmission Mechanism for Segmented Frames in Power Line Communication (PLC) Networks

(71) Applicant: TEXAS INSTRUMENTS INCORPORATED, Dallas, TX (US)

(72) Inventors: Kumaran Vijayasankar, Dallas, TX (US); Ramanuja Vedantham, Allen, TX (US); Tarkesh Pande, Dallas, TX (US)

(21) Appl. No.: 13/916,879

(22) Filed: Jun. 13, 2013

Related U.S. Application Data
(60) Provisional application No. 61/662,144, filed on Jun. 20, 2012.

(51) Int. Cl. H04B 3/54

(52) U.S. Cl. CPC H04B 3/54
USPC 370/447; 370/462

(57) ABSTRACT

Embodiments of methods and systems for transmitting and receiving segmented frames in a Power Line Communication (PLC) network are disclosed. A transmitter sends a first segment using CSMA/CA based on the priority of frame. All the other segments are transmitted using the CFS slot. When an ACK is received, transmitter sends the next segment after CFS. When a NACK is received, the transmitter sends just the last segment after CFS. If no ACK/NACK is received, the transmitter sends the last segment using CSMA/CA. If a NO_EARLIER_SEGMENTS delimiter is received, the transmitter sends the frame starting from the first segment using CSMA/CA. A receiver may send the NO_EARLIER_SEGMENTS delimiter when no earlier segments are in a receive buffer for reassembly. If the receiver is expecting to continue the reassembly of another frame when a segment is received, the receiver may transmit a BUSY_REASSEMBLY delimiter.

### CROSS-REFERENCE TO RELATED APPLICATIONS:

This application claims the benefit of the filing date of U.S. Provisional Patent Application No. 61/662,144, which is titled “Effective Retransmission Mechanism for Segmented Frames” and was filed on Jun. 20, 2012, the disclosure of which is hereby incorporated by reference herein in its entirety.

### BACKGROUND

Power line communications (PLC) include systems for communicating data over the same medium that is also used to transmit electric power to residences, buildings, and other premises, such as wires, power lines, or other conductors. In its simplest terms, PLC modulates communication signals over existing power lines. This enables devices to be networked without introducing any new wires or cables. This capability is extremely attractive across a diverse range of applications that can leverage greater intelligence and efficiency through networking. PLC applications include utility meters, home area networks, and appliance and lighting control.

PLC is a generic term for any technology that uses power lines as a communications channel. Various PLC standardization efforts are currently in work around the world. The different standards focus on different performance factors and issues relating to particular applications and operating environments. Two of the most well-known PLC standards are G3 and PRIME. G3 has been approved by the International Telecommunication Union (ITU). IEEE is developing the IEEE P1901.2 standard that is based on G3. Each PLC standard has its own unique characteristics.

Using PLC to communicate with utility meters enables applications such as Automated Meter Reading (AMR) and Automated Meter Infrastructure (AMI) communications without the need to install additional wires. Consumers may also use PLC to connect home electric meters to an energy monitoring device or in-home display monitor their energy consumption and to leverage lower-cost electric pricing based on time-of-day demand.

As the home area network expands to include controlling home appliances for more efficient consumption of energy, OEMs may use PLC to link these devices and the home network. PLC may also support home and industrial automation by integrating intelligence into a wide variety of lighting products to enable functionality such as remote control of lighting, automated activation and deactivation of lights, monitoring of usage to accurately calculate energy costs, and connectivity to the grid.

The manner in which PLC systems are implemented depends upon local regulations, characteristics of local power grids, etc. The frequency band available for PLC users depends upon the location of the system. In Europe, PLC bands are defined by the CENELEC (European Committee for Electrotechnical Standardization). The CENELEC-A band (3 kHz-95 kHz) is exclusively for energy providers. The CENELEC-B, C, D bands are open for end user applications, which may include PLC users. Typically, PLC systems operate between 35-90 kHz in the CENELEC A band using 36 tones spaced 1.5675 kHz apart. In the United States, the FCC has conducted emissions requirements that start at 535 kHz and therefore the PLC systems have an FCC band defined from 154-487.5 kHz using 72 tones spaced at 4.6875 kHz apart. In other parts of the world different frequency bands are used, such as the Association of Radio Industries and Businesses (ARIB)-defined band in Japan, which operates at 10-450 kHz, and the Electric Power Research Institute (EPRI)-defined bands in China, which operates at 3-90 kHz.

In power line communications standards, such as G3/IEEE P1901.2, contention free slots have been used for segmentation/reassembly. Most standards, however, start retransmitting all of the segments from the beginning if one of the segments is not received or fails CRC. This can cause potential loss in throughput. A mechanism is needed to handle the retransmission more gracefully thereby improving the network performance.

### SUMMARY OF THE INVENTION

Embodiments of the invention are directed, in general, to Power Line Communication systems (PLC) and, more specifically, retransmissions for segmented frames. A transmitter sends a first segment using Carrier Sense Multiple Access with Collision Avoidance (CSMA/CA) based on the priority of frame. All the other segments are transmitted using the Contention Free Slot (CFS). When an ACK is received, transmitter sends the next segment after CFS. When a negative acknowledge frame (NACK) is received, the transmitter sends just the last segment after CFS. If no ACK/NACK is received, the transmitter sends the last segment using CSMA/CA. If a NO_EARLIER_SEGMENTS delimiter is received, the transmitter sends the frame starting from the first segment using CSMA/CA. A receiver may send the NO_EARLIER_SEGMENTS delimiter when no earlier segments are in a receive buffer for reassembly. If the receiver is expecting to continue the reassembly of another frame when a segment is received, the receiver may transmit a BUSY_REASSEMBLY delimiter.

In one embodiment, a system and method for transmitting segmented frames in a PLC is disclosed. A transmitting node sends frame segments to a receiver via a PLC channel. The node retransmits a most-recent segment, if a negative acknowledgment or no acknowledgement is received for the most-recent segment. The node retransmits the frame segments to the receiver starting with a first segment, if a no-earlier-segments or busy-reject indication is received. The node uses CSMA/CA before retransmitting the frame segments, if a no-earlier-segments indication is received. The node retransmits the frame segments after an Extended InterFrame Space (EIFS) period, if a busy-reject indication is received. The no-earlier-segments indication or busy-reject indication may be a delimiter in a Frame Control Header (FCH). In other embodiments, the busy-rejection indication may be a busy-reassembly delimiter.

In another embodiment, a system and method for receiving segmented frames in a PLC network is disclosed. A node receives a frame segment from a transmitter via a PLC channel. The node transmits a no-earlier-segments indication or busy-reject indication to the transmitter in response to the frame segment. The node transmits the no-earlier-segments indication when no earlier segments associated with the received frame segment are stored in a receive buffer and the received frame segment is not a first segment. The node transmits the busy-reject indication when the receiver is continuing reassembly of a frame from a different transmitter.

### BRIEF DESCRIPTION OF THE DRAWINGS

Having thus described the invention in general terms, reference will now be made to the accompanying drawings, wherein:

FIG. 1 is a diagram of a PLC system according to some embodiments.

FIG. 2 is a block diagram of a PLC device or modem according to some embodiments.

FIG. 3 is a block diagram of a PLC gateway according to some embodiments.

FIG. 4 is a block diagram of a PLC data concentrator according to some embodiments.

FIG. 5 is a schematic block diagram illustrating one embodiment of a system configured for point-to-point PLC.

FIG. 6 is a block diagram of an integrated circuit according to some embodiments.

FIG. 7 illustrates an example embodiment of a PLC network for a local utility PLC communications system.

FIG. 8 illustrates a PLC transmitter sending segments to a PLC receiver where the received segments pass CRC.

FIG. 9 illustrates a PLC transmitter sending segments to a PLC receiver where one of the received segments fails CRC.

FIG. 10 illustrates the case where a PLC transmitter sending segments to a PLC receiver where the receiver does not get one of the segments.

FIG. 11 illustrates the case where a receiver has started reassembly of another frame.

FIG. 12 illustrates the case where a receiver intends to continue with a current reassembly.

### DETAILED DESCRIPTION

The invention now will be described more fully hereinafter with reference to the accompanying drawings. This invention may, however, be embodied in many different forms and should not be construed as limited to the embodiments set forth herein. Rather, these embodiments are provided so that this disclosure will be thorough and complete, and will fully convey the scope of the invention to those skilled in the art. One skilled in the art may be able to use the various embodiments of the invention.

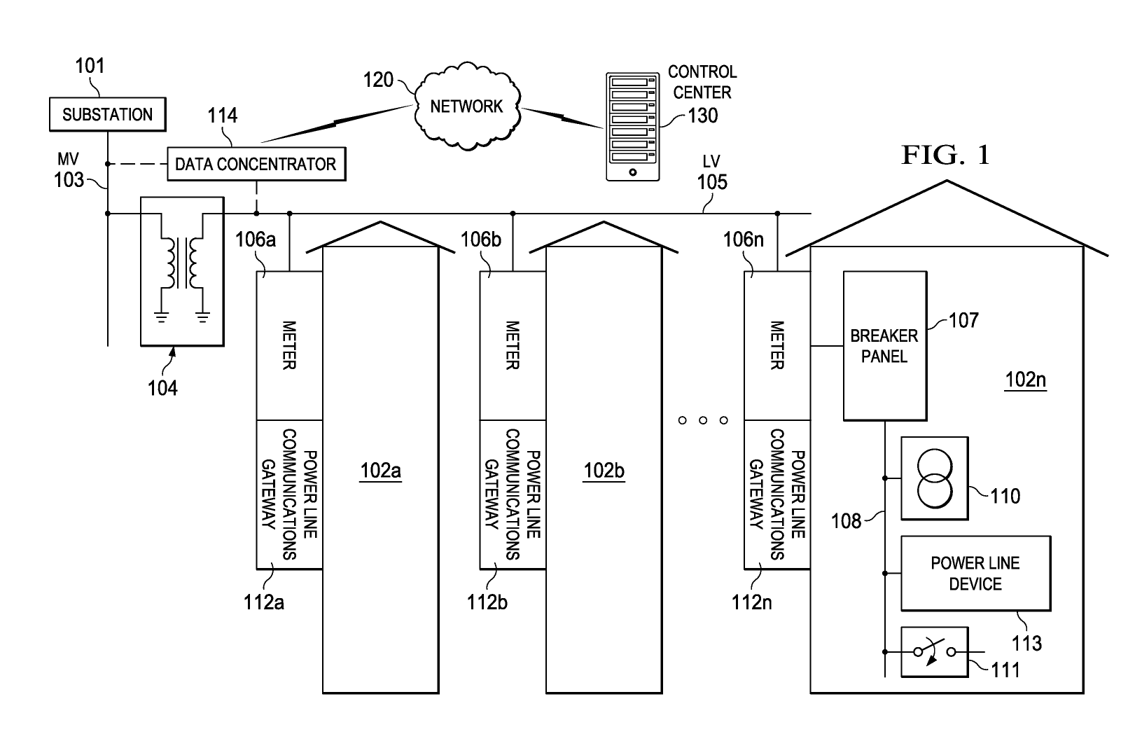

FIG. 1 illustrates a power line communication network according to some embodiments. Medium voltage (MV) power lines 103 from subnode 101 typically carry voltage in the tens of kilovolts range. Transformer 104 steps the MV power down to low voltage (LV) power on LV lines 105, carrying voltage in the range of 100-240 VAC. Transformer 104 is typically designed to operate at very low frequencies in the range of 50-60 Hz. Transformer 104 does not typically allow high frequencies, such as signals greater than 100 KHz, to pass between LV lines 105 and MV lines 103. LV lines 105 feed power to customers via meters or nodes 106a-n, which are typically mounted on the outside of residences 102a-n. Although referred to as “residences,” premises 102a-n may include any type of building, facility, electric vehicle charging node, or other location where electric power is received and/or consumed. A breaker panel, such as panel 107, provides an interface between meter 106n and electrical wires 108 within residence 102n. Electrical wires 108 deliver power to outlets 110, switches 111 and other electric devices within residence 102n.

The power line topology illustrated in FIG. 1 may be used to deliver high-speed communications to residences 102a-n. In some implementations, power line communications modems or gateways 112a-n may be coupled to LV power lines 105 at meter 106a-n. PLC modems/gateways 112a-n may be used to transmit and receive data signals over MV/LV lines 103/105. Such data signals may be used to support metering and power delivery applications (e.g., smart grid applications), communication systems, high speed Internet, telephony, video conferencing, and video delivery, to name a few. By transporting telecommunications and/or data signals over a power transmission network, there is no need to install new cabling to each subscriber 102a-n. Thus, by using existing electricity distribution systems to carry data signals, significant cost savings are possible.

An illustrative method for transmitting data over power lines may use a carrier signal having a frequency different from that of the power signal. The carrier signal may be modulated by the data, for example, using an OFDM technology or the like described, for example, G3-PLC standard.

PLC modems or gateways 112a-n at residences 102a-n use the MV/LV power grid to carry data signals to and from PLC data concentrator or router 114 without requiring additional wiring. Data concentrator or router 114 may be coupled to either MV line 103 or LV line 105. Modems or gateways 112a-n may support applications such as high-speed broadband Internet links, narrowband control applications, low bandwidth data collection applications, or the like. In a home environment, for example, modems or gateways 112a-n may further enable home and building automation in heat and air conditioning, lighting, and security. Also, PLC modems or gateways 112a-n may enable AC or DC charging of electric vehicles and other appliances. An example of an AC or DC charger is illustrated as PLC device 113. Outside the premises, power line communication networks may provide street lighting control and remote power meter data collection.

One or more PLC data concentrators or routers 114 may be coupled to control center 130 (e.g., a utility company) via network 120. Network 120 may include, for example, an IP-based network, the Internet, a cellular network, a WiFi network, a WiMax network, or the like. As such, control center 130 may be configured to collect power consumption and other types of relevant information from gateway(s) 112 and/or device(s) 113 through concentrator(s) 114. Additionally or alternatively, control center 130 may be configured to implement smart grid policies and other regulatory or commercial rules by communicating such rules to each gateway(s) 112 and/or device(s) 113 through concentrator(s) 114.

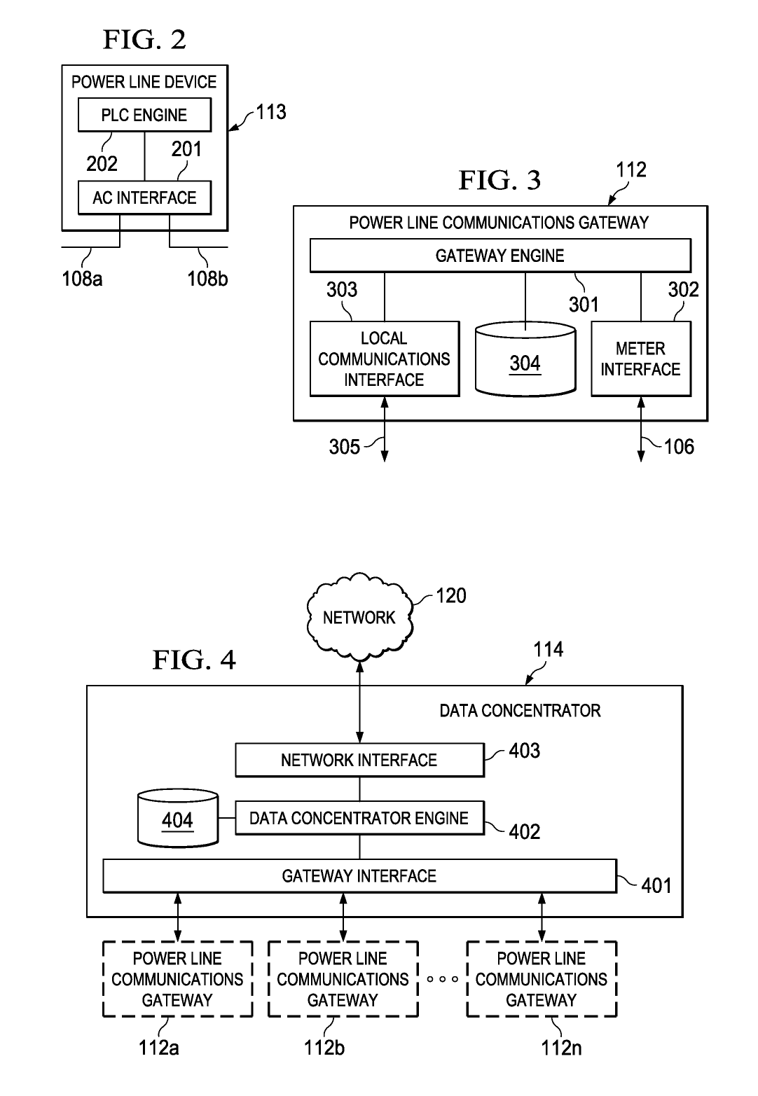

FIG. 2 is a block diagram of PLC device 113 according to some embodiments. As illustrated, AC interface 201 may be coupled to electrical wires 108a and 108b inside of premises 112n in a manner that allows PLC device 113 to switch the connection between wires 108a and 108b off using a switching circuit or the like. In other embodiments, however, AC interface 201 may be connected to a single wire 108 (i.e., without breaking wire 108 into wires 108a and 108b) and without providing such switching capabilities. In operation, AC interface 201 may allow PLC engine 202 to receive and transmit PLC signals over wires 108a-b. In some cases, PLC device 113 may be a PLC modem. Additionally or alternatively, PLC device 113 may be a part of a smart grid device (e.g., an AC or DC charger, a meter, etc.), an appliance, or a control module for other electrical elements located inside or outside of premises 112n (e.g., street lighting, etc.).

PLC engine 202 may be configured to transmit and/or receive PLC signals over wires 108a and/or 108b via AC interface 201 using a particular frequency band. In some embodiments, PLC engine 202 may be configured to transmit OFDM signals, although other types of modulation schemes may be used. As such, PLC engine 202 may include or otherwise be configured to communicate with metrology or monitoring circuits (not shown) that are in turn configured to measure power consumption characteristics of certain devices or appliances via wires 108, 108a, and/or 108b. PLC engine 202 may receive such power consumption information, encode it as one or more PLC signals, and transmit it over wires 108, 108a, and/or 108b to higher-level PLC devices (e.g., PLC gateways 112n, data aggregators 114, etc.) for further processing. Conversely, PLC engine 202 may receive instructions and/or other information from such higher-level PLC devices encoded in PLC signals, for example, to allow PLC engine 202 to select a particular frequency band in which to operate.

FIG. 3 is a block diagram of PLC gateway 112 according to some embodiments. As illustrated in this example, gateway engine 301 is coupled to meter interface 302, local communication interface 304, and frequency band usage database 304. Meter interface 302 is coupled to meter 106, and local communication interface 304 is coupled to one or more of a variety of PLC devices such as, for example, PLC device 113. Local communication interface 304 may provide a variety of communication protocols such as, for example, ZigBee, Bluetooth, Wi-Fi, Wi-Max, Ethernet, etc., which may enable gateway 112 to communicate with a wide variety of different devices and appliances. In operation, gateway engine 301 may be configured to collect communications from PLC device 113 and/or other devices, as well as meter 106, and serve as an interface between these various devices and PLC data concentrator 114. Gateway engine 301 may also be configured to allocate frequency bands to specific devices and/or to provide information to such devices that enable them to self-assign their own operating frequencies.

In some embodiments, PLC gateway 112 may be disposed within or near premises 102n and serve as a gateway to all PLC communications to and/or from premises 102n. In other embodiments, however, PLC gateway 112 may be absent and PLC devices 113 (as well as meter 106n and/or other appliances) may communicate directly with PLC data concentrator 114. When PLC gateway 112 is present, it may include database 304 with records of frequency bands currently used, for example, by various PLC devices 113 within premises 102n. An example of such a record may include, for instance, device identification information (e.g., serial number, device ID, etc.), application profile, device class, and/or currently allocated frequency band. As such, gateway engine 301 may use database 305 in assigning, allocating, or otherwise managing frequency bands assigned to its various PLC devices.

FIG. 4 is a block diagram of PLC data concentrator or router 114 according to some embodiments. Gateway interface 401 is coupled to data concentrator engine 402 and may be configured to communicate with one or more PLC gateways 112a-n. Network interface 403 is also coupled to data concentrator engine 402 and may be configured to communicate with network 120. In operation, data concentrator engine 402 may be used to collect information and data from multiple gateways 112a-n before forwarding the data to control center 130. In cases where PLC gateways 112a-n are absent, gateway interface 401 may be replaced with a meter and/or device interface (now shown) configured to communicate directly with meters 116a-n, PLC devices 113, and/or other appliances. Further, if PLC gateways 112a-n are absent, frequency usage database 404 may be configured to store records similar to those described above with respect to database 304.

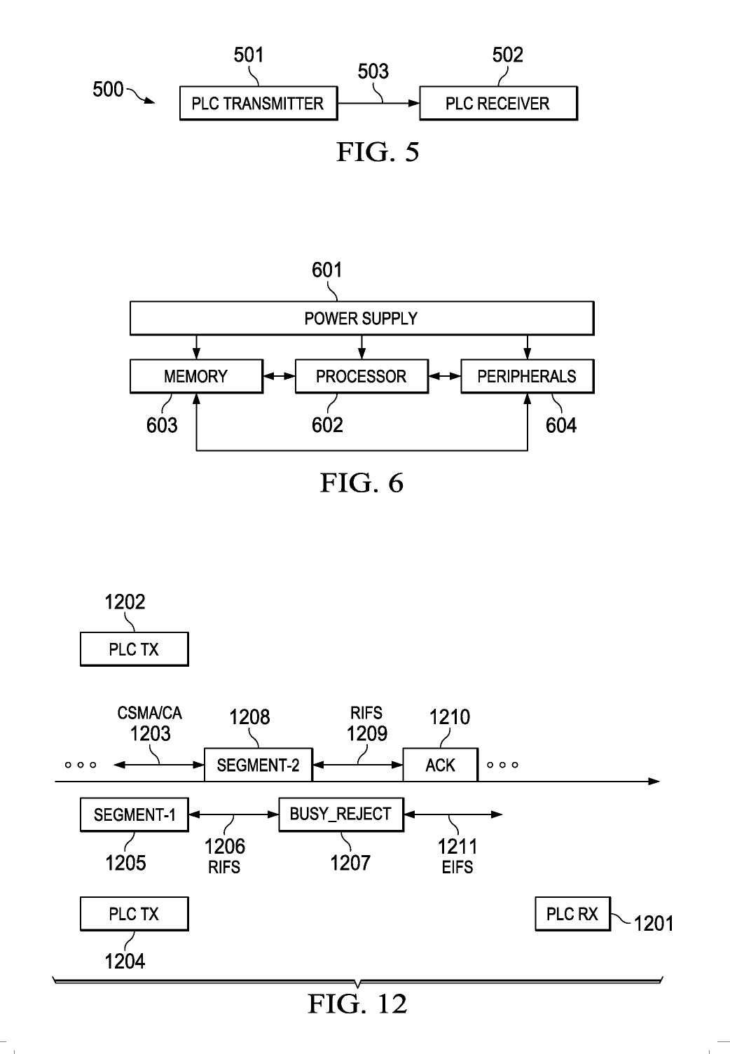

FIG. 5 is a schematic block diagram illustrating one embodiment of a system 500 configured for point-to-point PLC. The system 500 may include a PLC transmitter 501 and a PLC receiver 502. For example, a PLC gateway 112 may be configured as the PLC transmitter 501 and a PLC device 113 may be configured as the PLC receiver 502. Alternatively, the PLC device 113 may be configured as the PLC transmitter 501 and the PLC gateway 112 may be configured as the PLC receiver 502. In still a further embodiment, the data concentrator 114 may be configured as either the PLC transmitter 501 or the PLC receiver 502 and configured in combination with a PLC gateway 112 or a PLC device 113 in a point-to-point system 500. In still a further embodiment, a plurality of PLC devices 113 may be configured to communicate directly in a point-to-point PLC system 500 as described in FIG. 5. Additionally, the subnode 101 may be configured in a point-to-point system 500 as described above. On of ordinary skill in the art will recognize a variety of suitable configurations for the point-to-point PLC system 500 described in FIG. 5.

FIG. 6 is a block diagram of a circuit for implementing the transmission of multiple beacon frames using different modulation techniques on each tone mask in a PLC network according to some embodiments. In some cases, one or more of the devices and/or apparatuses shown in FIGS. 1-5 may be implemented as shown in FIG. 6. In some embodiments, processor 602 may be a digital signal processor (DSP), an application specific integrated circuit (ASIC), a system-on-chip (SoC) circuit, a field-programmable gate array (FPGA), a microprocessor, a microcontroller, or the like. Processor 602 is coupled to one or more peripherals 604 and external memory 603. In some cases, external memory 603 may be used to store and/or maintain databases 304 and/or 404 shown in FIGS. 3 and 4. Further, processor 602 may include a driver for communicating signals to external memory 603 and another driver for communicating signals to peripherals 604. Power supply 601 provides supply voltages to processor 602 as well as one or more supply voltages to memory 603 and/or peripherals 604. In some embodiments, more than one instance of processor 602 may be included (and more than one external memory 603 may be included as well).

Peripherals 604 may include any desired circuitry, depending on the type of PLC system. For example, in an embodiment, peripherals 604 may implement local communication interface 303 and include devices for various types of wireless communication, such as Wi-Fi, ZigBee, Bluetooth, cellular, global positioning system, etc. Peripherals 604 may also include additional storage, including RAM storage, solid-state storage, or disk storage. In some cases, peripherals 604 may include user interface devices such as a display screen, including touch display screens or multi-touch display screens, keyboard or other input devices, microphones, speakers, etc.

External memory 603 may include any type of memory. For example, external memory 603 may include SRAM, nonvolatile RAM (NVRAM, such as “flash” memory), and/or dynamic RAM (DRAM) such as synchronous DRAM (SDRAM), double data rate (DDR, DDR2, DDR3, etc.) SDRAM, DRAM, etc. External memory 603 may include one or more memory modules to which the memory devices are mounted, such as single inline memory modules (SIMMs), dual inline memory modules (DIMMs), etc.

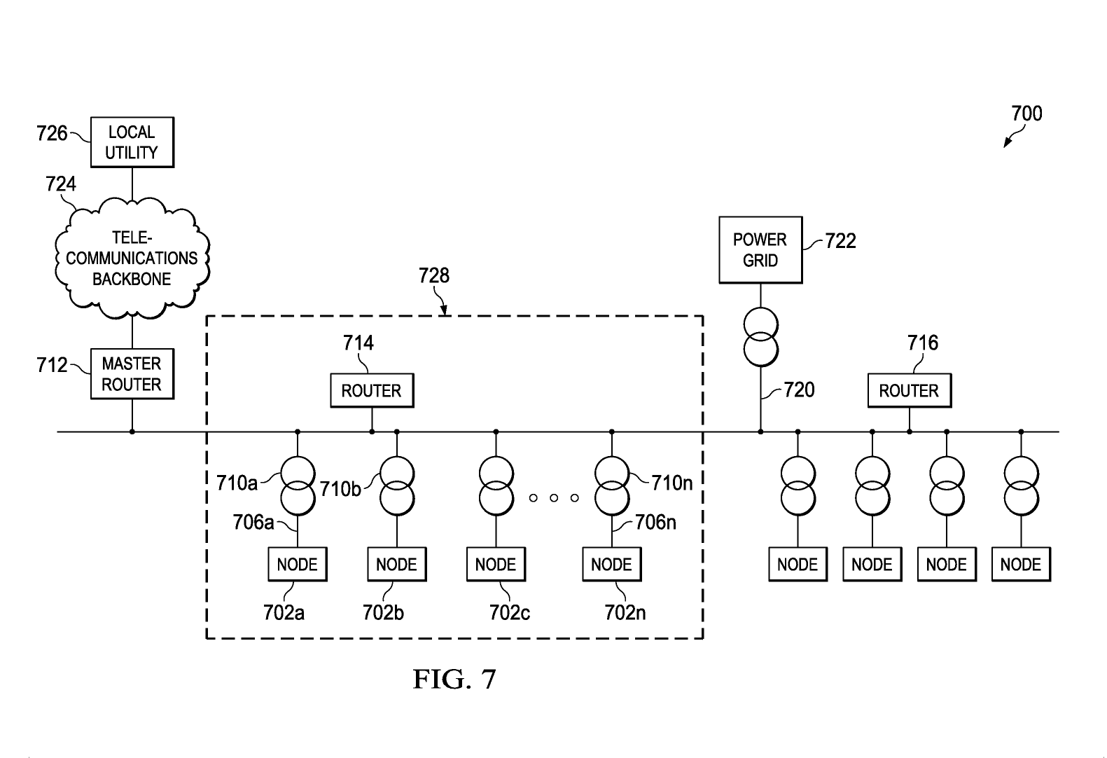

FIG. 7 illustrates an example embodiment of a PLC network 700 for a local utility PLC communications system. Network 700 includes LV nodes 702a-n and each of the nodes 702a-n is connected to MV power line 720 through a corresponding transformer 710a-nand LV line 706a-n. Router, or modem, 714 is also connected to MV power line 720. A sub-network 728, or neighborhood 728, may be represented by the combination of nodes 702a-n and router 714. Master router 712 and router 716 are also connected to MV line 720, which is powered by power grid 722. Power grid 722 represents the high voltage power distribution system.

Master router 712 may be the gateway to telecommunications backbone 724 and local utility, or control center, 726. Master router 712 may transmit data collected by the routers to the local utility 726 and may also broadcast commands from local utility 726 to the rest of the network. The commands from local utility 726 may require data collection at prescribed times, changes to communication protocols, and other software or communication updates.

During UL communications, the nodes 702a-n in neighborhood 728 may transmit usage and load information (“data”) through their respective transformer 710a-n to the MV router 714. In turn, router 714 forwards this data to master router 712, which sends the data to the utility company 726 over the telecommunications backbone 724. During DL communications (router 714 to nodes 702a-n) requests for data uploading or commands to perform other tasks are transmitted.

In accordance with various embodiments, nodes 702a-n employ a CSMA/CA mechanism that combines energy detection and preamble detection to access the PLC network. The nodes may do either of the following CSMA/CA methods to access the channel: (1) run energy detection first and then use preamble detection only after energy detection returns positive, or (2) run both energy detection and preamble detection simultaneously. The CSMA-CA algorithm is used before the transmission of data or MAC command frames.

Segmentation and reassembly.

Medium access control (MAC) entities in different PLC devices may communicate using MAC frames. A MAC frame comprises, for example, a MAC header (MHR), a MAC payload, and a MAC footer (MFR). The MAC payload may comprise a MAC Service Data Unit (MSDU) and/or MAC commands to be transmitted by the PLC device. A large MAC frame may require segmentation. In this case, the original MAC frame may be replaced by several smaller MAC frames. The MAC payload of each smaller MAC frame comprises a fragment or segment of the original MAC payload.

A PHY frame in a PLC device comprises a PHY frame header (PFH), which includes preamble symbols and frame control header symbols, and a PHY payload, which may be a PHY Service Data Unit (PSDU). In a PLC network, the number of data octets of the PHY payload can change dynamically based on channel conditions. This requires implementing MAC payload fragmentation in the MAC sub-layer.

If the size of the MAC payload (i.e., MSDU or MAC command) plus the MAC header and footer is too large to fit within one PSDU, then the MAC payload is partitioned into smaller segments such that each segment (plus a MAC header and footer) can fit within a PSDU. This process of partitioning the MAC payload into PSDUs is called segmentation and the reverse process is called reassembly. MAC payload segmentation is done by dividing the MAC payload into multiple smaller amounts of data (segments) depending on PSDU size. The segmentation may require the addition of padding bytes to the last payload segment so that the final MAC Protocol Data Unit (MPDU) fills the PSDU.

A MAC Frame includes a segment control field that is used for reassembly of the segments. The segment control field is included in the MAC header for all MAC frames regardless of whether segmentation is required or not. The segment control field includes, for example, a Last Segment Flag (LSF) that is set to 1 to indicate the last segment of the MAC payload, and a Segment Count (SC) that is set to 0 for the first segment and then incremented for each subsequent segment. The PLC transmitter transmits the segments in ascending order of the segment count. A Segment Length (SL) in the segment control field specifies the length of the current MAC payload segment in bytes excluding the MAC header, MAC footer and byte padding (if any).

If segmentation is required to transmit a MAC payload, each resulting MAC frame (MPDU) may be created by the PLC transmitter as follows. All MAC frames, except the last one, set a Contention Control (CC) bit to inform the receiver that the next PHY frame will be sent in a CFS. The last MAC frame clears the Contention Control bit to allow normal contention access to the channel. Byte padding is used only in the last segment and only if needed. The MAC header (MHR) and FCS (MFR) are present in each segment. The segments all have the same Sequence Number value as assigned for the MAC packet and Segment Count is incremented for the segments following the first segment.

The PLC receiver buffers the received segments corresponding to a frame in its buffer. While buffering received segments for one frame, if a segment for a different frame is received, the receiver may start reassembling the new frame.

The PLC transmitter sends the first segment using CSMA/CA based on the priority of the frames. All the other segments for that frame are transmitted in the increasing order of segment count using the CFS slot. For frames that need acknowledgment, the transmitter will expect an Acknowledge frame (ACK) for each segment.

Transmitter behavior.

The transmitter PLC device's behavior after transmitting a segment of a frame for which acknowledgement is expected may be determined as follows:

a) If an ACK is received, transmit the next segment after CFS.

b) If a NACK is received, transmit the same segment after CFS (i.e., the receipt of the NACK indicates that the frame has reached the destination but was corrupted).

c) If no ACK/NACK is received, transmit the same segment using CSMA/CA.

d) If a NO_EARLIER_SEGMENTS delimiter is received, start transmitting from the first segment using CSMA/CA. In one embodiment, the Delimiter Type (DT) of 0b110 in the FCH may represent a NO_EARLIER_SEGMENTS frame. However, it will be understood that any other available or reserved DT value may be used to represent a NO_EARLIER_SEGMENTS frame.

e) If a BUSY_REASSEMBLY or BUSY_REJECT is received, then defer the transmission to the destination for an Extended InterFrame Space (EIFS) period. In one embodiment, the Delimiter Type (DT) of 0b111 in the Frame Control Header (FCH) may represent a BUSY_REASSEMBLY or BUSY_REJECT frame. However, it will be understood that any other available or reserved DT value may be used to represent a BUSY_REASSEMBLY or BUSY_REJECT frame, such as 0b100. Furthermore, it will be understood that the terms BUSY_REASSEMBLY and BUSY_REJECT may be used interchangeably in other embodiments to refer to the same delimiter.

Receiver behavior.

The receiver PLC device's behavior after receiving a segment of a frame may be determined as follows:

a) If a segment is received and the destination address does not match the receiver PLC device, drop the frame.

b) If a segment is received correctly (i.e., without Cyclic Redundancy Check (CRC) errors) and the earlier segments are already in buffer for reassembly, transmit an ACK.

c) If a segment is received correctly (i.e., without CRC errors), but the earlier segments are not already in buffer for reassembly, transmit a NO_EARLIER_SEGMENTS delimiter.

d) If a segment is received, but the receiver is expecting to continue the reassembly of another frame, transmit a BUSY_REASSEMBLY or BUSY_REJECT delimiter.

e) If a segment is received with CRC errors, but the destination address matches its address, transmit a NACK.

The NO_EARLIER_SEGMENTS, BUSY_REASSEMBLY and BUSY_REJECT delimiters may be used as follows in some embodiments:

A receiver may store the received segments in a reassembly buffer. If during reassembly, segments from another transmitter are received, then the receiver may choose to remove the earlier received segments and start the reassembly procedure for the new frame. On the other hand, the receiver may also choose to inform the other transmitter that it is performing a current reassembly and hence send a BUSY_REASSEMBLY or BUSY_REJECT delimiter to the other transmitter. It should be noted that the receiver may need to use a timeout for waiting to perform reassembly for the original frame as the transmitter may have dropped the transmissions for that frame.

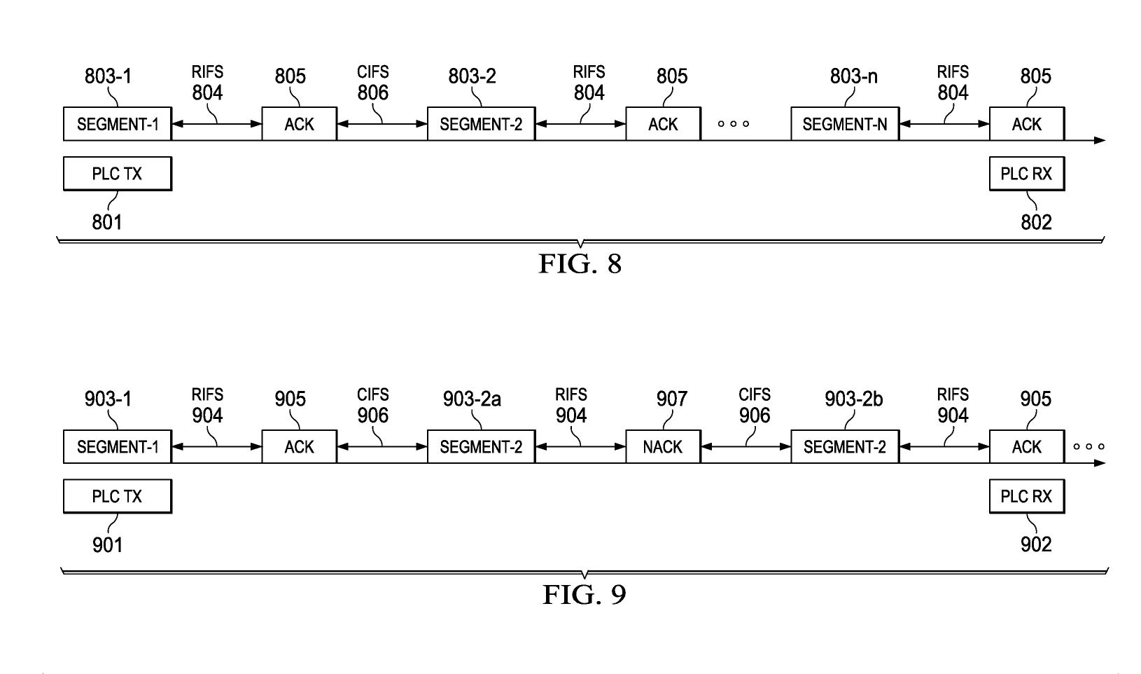

FIG. 8 illustrates a PLC transmitter 801 sending segments 803-n to a PLC receiver 802 where the received segments pass CRC. Each transmitted segment 803-n is followed by a Response InterFrame Space (RIFS) 804. After RIFS 804, the receiver 802 sends an ACK frame 805 to acknowledge that the respective segment 803-n has passed CRC. After receiving an ACK frame 805, the transmitter 801 waits for a Contention InterFrame Space (CIFS) 806 before sending the next segment 803-n+1. It will be understood that the RIFS and CIFS durations may be the same or different.

FIG. 9 illustrates a PLC transmitter 901 sending segments 903-n to a PLC receiver 902 where one of the received segments fails CRC. Each transmitted segment 903-n is followed by RIFS 904 and then the receiver 902 sends an ACK frame 905 to acknowledge that the respective segment 903-n has passed CRC. After receiving an ACK frame 905, the transmitter 901 waits for CIFS 906 before sending the next segment 903n+1. However, if a segment—such as the second segment 903-2a—fails CRC, then the receiver 902 will send NACK 907 after a RIFS 904. Upon receiving NACK 907, transmitter 901 will resend the second segment 903-2b after CIFS 906. If the retransmission 903-2b passes CRC, then the receiver 902 sends an ACK 905 and the transmitter continues to send the remaining segments, if any.

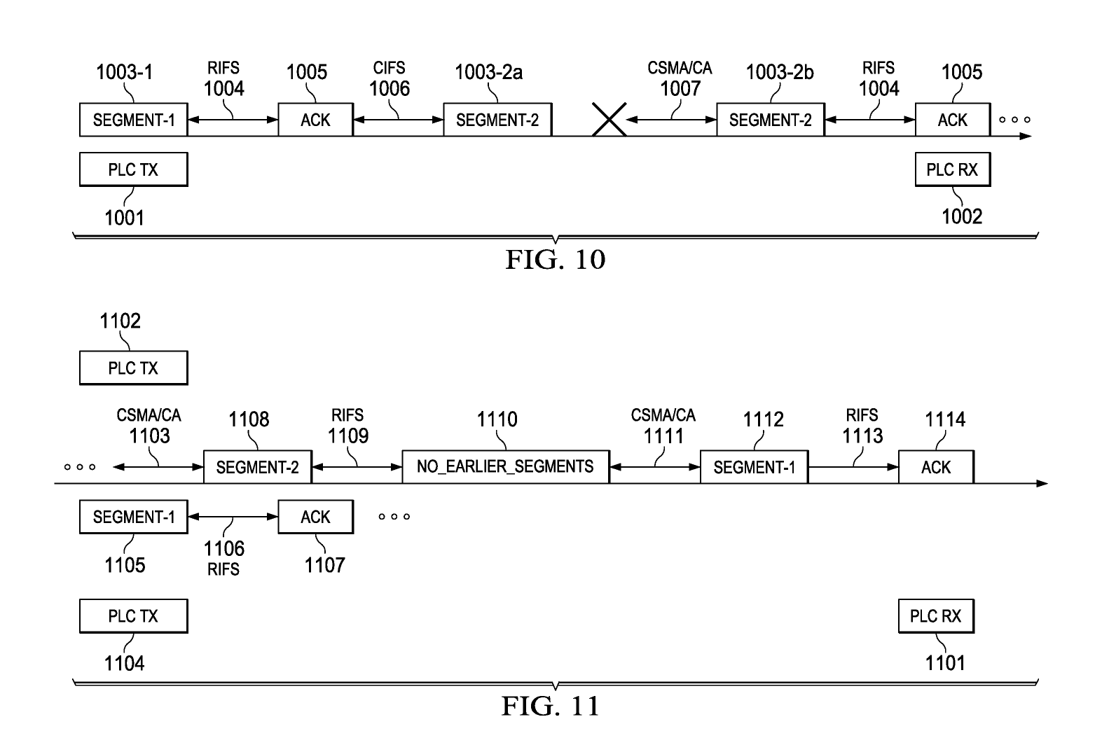

FIG. 10 illustrates the case where a PLC transmitter 1001 sending segments 1003-n to a PLC receiver 1002 but the receiver does not get one of the segments. Transmitter 1001 sends a first segment 1001-1 and receives an ACK 1005 after RIFS 1004. After CIFS 1006, the transmitter 1001 sends a second segment 1003-2a, but never receives an associated response from receiver 1002 for the second segment 1003-2a. In this case, the transmitter 1001 performs CSMA/CA 1007 using the appropriate backoff to access the channel again. Once transmitter 1001 successfully accesses the channel, it transmits the second segment again 1003-2b. When the retransmission of second segment 1003-2b is received and passes CRC, receiver 1002 sends an ACK 1005 after RIFS 1004.

FIG. 11 illustrates the case where a receiver 1101 has started reassembly of another frame. Receiver 1101 begins receiving and buffering initial segments (not shown) from transmitter 1102. However, before all of the segments are transmitted device 1102 loses the channel and must perform CSMA/CA 1103 to access the channel again. In the meantime, while transmitter 1102 is performing CSMA/CA, receiver 1101 begins receiving new segments from a second transmitter 1104. Upon receiving first segment 1105 from second transmitter 1104, receiver 1101 may start reassembly of the new frame from second transmitter 1104 instead of continuing to reassemble segments from the first transmitter 1102. In this situation, after RIFS 1106 receiver 1101 sends ACK 1107 to second transmitter 1104. Receiver 1101 also removes any segments previously received from first transmitter 1102 from its receive buffer.

When first transmitter 1102 has successfully accessed the channel again, it resends the last unacknowledged segment 1108 to receiver 1101. Because receiver 1101 has started reassembling the segments from second transmitter 1104 and has deleted the segments from first transmitter 1102, it sends a NO_EARLIER_SEGMENTS frame 1110 after RIFS 1109. This notifies the first transmitter 1102 that the receiver needs the segments that precede segment 1108 in order to reassemble the frame from the first transmitter 1102. Accordingly, first transmitter 1102 must access the again using CSMA/CA 1111. First transmitter 1102 starts over sending first segment 1112 for the current frame. If receiver 1101 is now ready to receive and reassemble the segments from first transmitter 1102, it will send ACK frame 1114 after RIFS 1113.

FIG. 12 illustrates the case where a receiver 1201 intends to continue with a current reassembly. Receiver 1201 begins receiving and buffering initial segments (not shown) from transmitter 1202. However, before all of the segments are transmitted device 1202 loses the channel and must perform CSMA/CA 1203 to access the channel again. In the meantime, receiver 1201 begins receiving new segments from a second transmitter 1204. Upon receiving first segment 1205 from second transmitter 1204, receiver 1201 determines that it will continue reassembling the segments from first transmitter 1201. In this situation, after RIFS 1206 receiver 1201 sends BUSY_REJECT (or BUSY_REASSEMBLY) frame 1207 to second transmitter 1204. After EIFS period 1211, second transmitter 1204 may again attempt to access the channel and resend its segments.

When first transmitter 1202 has successfully accessed the channel again, it resends the last unacknowledged segment 1208 to receiver 1201. Receiver 1201 sends ACK frame 1210 after RIFS 1209 and continues to receive and acknowledge additional segments from first transmitter 1202 as appropriate.

Many modifications and other embodiments of the invention(s) will come to mind to one skilled in the art to which the invention(s) pertain having the benefit of the teachings presented in the foregoing descriptions, and the associated drawings. Therefore, it is to be understood that the invention(s) are not to be limited to the specific embodiments disclosed. Although specific terms are employed herein, they are used in a generic and descriptive sense only and not for purposes of limitation.

What is claimed is:

1. A method for transmitting segmented frames in a power line communication (PLC) network, comprising:
transmitting frame segments to a receiver via a PLC channel; and
retransmitting a most-recent segment to the receiver, if a negative acknowledgment or no acknowledgement is received for the most-recent segment.

2. The method of claim 1, further comprising;
retransmitting the frame segments to the receiver starting with a first segment, if a no-earlier-segments indication or a busy-reject indication is received.

3. The method of claim 2, further comprising:
using Carrier Sense Multiple Access with Collision Avoidance (CSMA/CA) before retransmitting the frame segments, if a no-earlier-segments indication is received.

4. The method of claim 2, further comprising:
retransmitting the frame segments after an Extended InterFrame Space (EIFS) period, if a busy-reject indication is received.

5. The method of claim 2, wherein the no-earlier-segments indication or busy-reject indication is a delimiter in a frame control header.

6. The method of claim 2, wherein the busy-rejection indication is a busy-reassembly delimiter.

7. A method for receiving segmented frames in a power line communication (PLC) network, comprising:
receiving a frame segment from a transmitter via a PLC channel; and
transmitting a no-earlier-segments indication or a busy-reject indication to the transmitter in response to the frame segment.

8. The method of claim 7, further comprising:
transmitting the no-earlier-segments indication when no earlier segments associated with the received frame segment are stored in a receive buffer and the received frame segment is not a first segment.

9. The method of claim 7, further comprising:
transmitting the busy-reject indication when the receiver is continuing reassembly of a frame from a different transmitter.

10. The method of claim 7, wherein the no-earlier-segments indication and busy-reject indication are transmitted as a delimiter in a frame control header.

11. The method of claim 10, wherein the busy-rejection indication is a busy-reassembly delimiter.

12. A device for transmitting segmented frames in a power line communication (PLC) network, comprising:
a transmitter configured to transmit frame segments on a PLC channel to other PLC devices, and the transmitter further configured to retransmit a most-recent segment, if a negative acknowledgment or no acknowledgement is received for the most-recent segment; and
a receiver configured to receive frames from the other PLC devices.

13. The device of claim 12, wherein the transmitter is further configured to retransmit the frame segments starting with a first segment, if a no-earlier-segments or busy-reject indication is received from another PLC device.

14. The device of claim 13, wherein the transmitter is further configured to use Carrier Sense Multiple Access with Collision Avoidance (CSMA/CA) before retransmitting the frame segments, if a no-earlier-segments indication is received.

15. The device of claim 13, wherein the transmitter is further configured to retransmit the frame segments after an Extended InterFrame Space (EIFS) period, if a busy-reject indication is received.

16. The device of claim 12, wherein the receiver is further configured to identify a no-earlier-segments indication or a busy-reject indication as a delimiter in a frame control header received from other PLC devices.

17. A device for receiving segmented frames in a power line communication (PLC) network, comprising:
a receiver circuit configured to receive one or more frame segments from a remote PLC device via a PLC channel; and
a transmitter circuit configured to transmit a no-earlier-segments indication or a busy-reject indication to the remote PLC device in response to a received frame segments.

18. The device of claim 17, wherein the transmitter circuit is further configured to transmit the no-earlier-segments indication when no other segments associated with the received frame segment are stored in a receive buffer and the received frame segment is not a first segment.

19. The device of claim 17, wherein the transmitter circuit is further configured to transmit the busy-reject indication when the device is continuing reassembly of a frame from a different PLC device.
